(19) United States
(12) Patent Application Publication
(10) Pub. No.: US 2002/0149558 A1
(43) Pub. Date: Oct. 17, 2002

(54) Display device and its driving method, and projection-type display device

(76) Inventors: Tomohiro Kashima, Tokyo (JP); Katsuhide Uchino, Kanagawa (JP); Junichi Yamashita, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/049,520

(22) PCT Filed: Jun. 14, 2001
(86) PCT No.: PCT/JP01/05063

(30) Foreign Application Priority Data
Jun. 14, 2000 (JP) 2000-177927

(51) Int. Cl. G09G 3/36

(52) U.S. Cl. 345/100

(57) ABSTRACT

In a horizontal driving circuit 17 using a clock driving method in a point-sequence driving method active-matrix type display device, clocks DCK and DCKX having the same period and having a smaller duty ratio than horizontal clocks HCK and HCKX are generated at a clock generating circuit 18. These clocks DCK and DCKX are sampled by switches 22-1 to 22-4 of a clock sampling switch group 22. Then, by driving switches 23-1 to 23-4 of a sampling switch group 23 by these sampling pulses Vh1 to Vh4, a video signal VDO is sampled by perfectly non-overlapping sampling. As a result, occurrence of streaks on a display screen caused by overlapping sampling can be suppressed, and a ghost margin can be raised.

### TECHNICAL FIELD

The present invention relates to a display device and a method of driving same and to a projection type display device (projector), more particularly, relates to an active-matrix type display device using a point-sequence driving method employing a so-called clock driving method in a horizontal driving circuit and a method of driving the same and to a projection type display device.

### BACKGROUND ART

In a device display, for example, an active-matrix type liquid crystal display device using liquid crystal cells as pixel display elements (electro-optical elements), a horizontal driving circuit using the point-sequence driving method which employ for example a clock driving method has been known. A conventional example of this clock driving method is shown in FIG. 1. In FIG. 1, a horizontal driving circuit 100 is comprised of a shift register 101, clock sampling switch group 102, and sampling switch group 103.

The shift register 101 is formed of n number of shift stages (transfer stages). When a horizontal start pulse HST is given, the shift register 101 performs a shift operation in synchronization with the opposite phase horizontal clocks HCK and HCKX. As a result, the shift stages of the shift register 101, as shown in the timing charts of FIGS. 2A to 2F, sequentially output the shift pulses Vs1 to Vsn having the same pulse width as the period of the horizontal clocks HCK and HCKX. These shift pulses Vs1 to Vsn are supplied to switches 102-1 to 102-n of the clock sampling switch group 102.

Ends of each of the switches 102-1 to 102-n of the clock sampling switch group 102 are alternately connected to clock lines 104-1 and 104-2 receiving the horizontal clocks HCK and HCKX as input. As a result of the shift pulses Vs1 to Vsn being given in sequence from each shift stage of the shift register 101, the switches 102-1 to 102-n are turned on in sequence and sample the horizontal clocks HCKX and HCK. Each of these sampled pulses is supplied, as the sampling pulses Vhl to Vhn, to switches 103-1 to 103-n of the sampling switch group 103.

One end of each of the switches 103-1 to 103-n of the sampling switch group 103 is connected to a video line 105 transmitting a video signal VOD. The switches 103-1 to 103-n turn on in sequence in response to the sampling pulses Vhl to Vhn which are supplied in sequence as a result of being sampled by the switches 102-1 to 102-n of the clock sampling switch group 102, thereby sampling the video signal VDO, and supply it to signal lines 106-1 to 106-n of a pixel part (not illustrated).

However, in the horizontal driving circuit 100 using the clock driving method according to the above-described conventional example, during the transmission process from when the horizontal clocks HCKX and HCK are sampled by the switches 102-1 to 102-n of the clock sampling switch group 102 until these are supplied as the sampling pulses Vh1 to Vhn to the switches 103-1 to 103-n of the sampling switch group 103, a delay occurs in the pulses due to wiring resistance, parasitic capacitance, etc.

Due to the delay of the pulses in this transmission process, rounding occurs in the waveform of the sampling pulses Vh1 to Vhn. As a result, when for example the sampling pulse Vh2 of the second stage is considered, as is clear from, in particular, the timing charts of FIGS. 3A to 3C, the waveform of the sampling pulse Vh2 of the second stage overlaps the waveforms of the sampling pulses Vh1 and Vh3 of the first and third stages before and after this.

Generally speaking, at the instant when each of the switches 103-1 to 103-n of the sampling switch group 103 is turned on, a charging/discharging noise is carried on the video line 105 as shown in FIG. 3D, due to the relationship of the potential with the signal lines 103-1 to 103-n.

Under such circumstances, as mentioned above, when the sampling pulse Vh2 is overlapping between the previous and subsequent stages, at the sampling timing of the second stage based on the sampling pulse Vh2, a charging/discharging noise occurring as a result of the sampling switch 103-3 of the third stage being turned on is sampled. Note that, the sampling switches 103-1 to 103-n will sample and hold the potential of the video line 105 at a timing in which the sampling pulses Vh1 to Vhn reach an L level.

At this time, since variations occur in the charging/discharging noise which is carried on the video line 105 and variations also occur in the timing at which each of the sampling pulses Vh1 to Vhn reaches an L level, variations also occur in the potential of sampling by the sampling switches 103-1 to 103-n. As a result, the variations of this sampling potential appear as a streak on the display screen, and the image quality is degraded.

On the other hand, in the active-matrix type liquid crystal display device using the point-sequence driving method, when the number of pixels particularly in a horizontal direction increases along with higher definition, it becomes difficult to secure a sampling time long enough to sample all pixels in sequence in a limited horizontal valid period for the video signal VDO input by one system. Therefore, in order to sufficiently secure the sampling time, as shown in FIG. 4, there is employed a method wherein video signals are input in parallel by m number of systems (m is an integer of 2 or more), while m number of sampling switches are provided in units of m number of pixels in the horizontal direction as and m number of sampling switches are simultaneously driven by one sampling pulse so as to thereby perform a writing operation in sequence in units of m pixels.

Here, a case where a thin black line having a width of the unit number m of pixels or less is displayed will be considered. When such a black line is displayed, the video signal VDO, as shown in FIG. 5A, has a portion of a black level BLVL in a pulse state. The pulse width thereof is input as a waveform equal to the pulse width of a sampling pulse SMPL as shown in FIG. 5B. This pulse-state video signal VDO is ideally a rectangular wave, but the rising or falling edge of the pulse waveform becomes rounded (video signal VDO′) as shown in FIG. 5C due to the wiring resistance, parasitic capacitance, etc. of the video line for transmitting the video signal VDO. Note that, BGLVL of FIGS. 5A and 5C indicate background gray levels.

In this way, when the pulse-state video signal VDO′ having the rounded rising and falling edges is sampled and held by the sampling pulses Vh1 to Vhn, although the pulse-state video signal VDO′ must be originally sampled and held by the sampling pulse Vhk of a k-th stage, a rising portion of the video signal VDO is sampled and held by a sampling pulse Vhk−1 of the previous stage, or a falling portion of the video signal VDO′ is sampled and held by a sampling pulse Vhk+1 of the subsequent stage. As a result, ghosts occur. Here, a “ghost” means an undesirable interference occurring by overlap shifted from the normal image.

The phase relationship of the video signal VDO′ (hereinafter simply referred to as the “video signal VDO”) with respect to the sampling pulse Vbk can be altered to six stages of for example S/H=0 to 5 as shown in FIGS. 6A to 6I by adjusting the position of the video signal VDO on the time axis, that is, the sampling and holding position, in the circuit for processing the video signal VDO.

Here, a dependency of the occurrence of a ghost on the sampling and holding will be explained. First, the time when S/H=1 will be considered. The phase relationships of the video signal VDO when S/H=1 with the sampling pulses (SMPL) Vhk−1, Vhk, and Vhk+1 and the change of the potential PLS of the signal line are shown in FIGS. 7A to 7G. Note that, BLVL of FIG. 7A indicates the black level, and BGLVL indicates the background gray level.

When S/H=1, by the pulse-state video signal VDO being sampled and held by the sampling pulse Vhk, the black signal is written into the k-th signal line and the black line BLN is displayed as shown in FIG. 8.

However, since the black signal section (pulse section) of the video signal VDO overlaps the sampling pulse Vhk−1 of the (K−1)-th stage, the black signal is written also into the signal line of the (k−1)-th stage. By this, as shown in FIG. 8, a ghost GST occurs at the position of the (K−1)-th stage, that is, in front in a horizontal scanning direction HSCND (VSCND indicates a vertical scanning direction). Similarly, when S/H=0, the sampling pulse Vhk−1 of the (K−1)-th stage and the black signal section of the video signal VDO overlap each other, so a ghost GST occurs in front in the horizontal scanning direction HSCND.

Next, a time when S/H=5 will be considered. The phase relationships of the video signal VDO when S/H=5 with the sampling pulses (SMPL) Vhk−1, Vhk, and Vhk+1 and the change of the potential PLS of the signal line are shown in FIGS. 9A to 9G. Note that, BLVL of FIG. 9A indicates the black level, and BGLVL indicates the background gray level.

When S/H=5, the video black signal overlaps the sampling pulse Vhk+1 of the (K+1)-th stage. The black signal is written into the signal line of the (K+1)-th stage when the sampling switch is turned on, then the line tries to return to the gray level. However, since the amount of overlap is large, the potential of the signal line does not completely return to the gray level BGLVL by the amount indicated by NRTN in FIG. 9G. For this reason, as shown in FIG. 10, a ghost GST occurs at the position of the (K+1)-th stage, that is, behind in the horizontal scanning direction HSCND.

When S/H=1 to 4 as well, in the same way as when S/H=5, the sampling pulse Vhk+1 of the (K+1)-th stage and the video black signal section overlap with each other, and the black signal is written into the signal line when the sampling switch is turned on. However, the amount of overlap is smaller and the written black level is lower in comparison with the time when S/H=5, so the potential of the signal line can completely return to the gray level. Accordingly, no ghost occurs.

In the process as mentioned above, a ghost occurs due to the overlap of the video signal VDO and the sampling pulse. Here, the number of the sampling and holding positions at which a ghost does not occur at any position of before and after that, for example S/H=2, 3, 4, will be referred to as the margin of safety with respect to a ghost (hereinafter, referred to as a “ghost margin”).

In this way, even if the problem of the rounding of the waveform occurring at the rising and falling edges of the pulse-state video signal VDO due to the wiring resistance, parasitic capacitance, etc. of the video line cannot be avoided, by setting the optimum sampling and holding position in the circuit portion for processing the video signal VDO, the occurrence of ghosts can be avoided.

However, due to the rounding of the waveform occurring in the rising and falling edges of the pulse-state video signal VDO due to the wiring resistance, parasitic capacitance, etc. of the video line, the pulse waveform portion of the related video signal VDO overlaps the sampling pulse of the previous stage or subsequent stage, so it is impossible to obtain a larger ghost margin by that amount. In the above-described example, the ghost margins becomes the three S/H=2, 3, and 4.

### DISCLOSURE OF THE INVENTION

To attain the above object, in the present invention, there is provided a display device for obtaining shift pulses in sequence in synchronization with a first clock signal at the time of horizontal scanning with respect to a pixel part comprised by pixels arranged in a matrix and having a signal line arranged for each pixel string and for supplying a video signal to the signal line of said pixel part while sampling the video signal based on these shift pulses, wherein a second clock signal having the same period and having a smaller duty ratio than the first clock signal is generated, the second clock pulse is sampled based on the shift pulse and used as the sampling pulse, and the video signal is supplied to a signal line of the pixel part while sampling the video signal by this sampling pulse.

In the above configuration, each switch of the first switch group samples a second clock signal in sequence in response to a shift pulse which is output in sequence in synchronization with a first clock signal from the shift register. As a result, the second clock signal having a duty ratio smaller than that of the first clock signal is supplied, as a sampling signal, to the second switch group. Then, each switch of the second switch group samples and holds the input video signal in sequence in response to these sampling signals and supplies the signal to the signal line of the pixel part. At this time, since the duty ratio of the sampling signal is smaller than that of the first clock signal, perfectly non-overlapping sampling can be realized.

### BRIEF DESCRIPTION OF THE DRAWINGS

FIG. 1 is a block diagram of an example of the configuration of a clock driving method horizontal driving circuit according to a conventional example.

FIGS. 2A to 2I are timing charts for explaining an operation of the clock driving method horizontal driving circuit according to the conventional example.

FIGS. 3A to 3D are timing charts at the time of a sampling operation of a video signal in the clock driving method horizontal driving circuit according to the conventional example.

FIG. 4 is a view of the configuration of a sampling switch group where video signals are input in parallel by m number of systems.

FIGS. 5A to 5C are diagrams of waveforms showing a state where rounding occurs in the pulse-state video signal.

FIGS. 6A to 6I are timing charts showing phase relationships between a video signal VDO taking sampling and holding positions of S/H=0 to 5 and overlapped sampling pulses Vhk−1, Vhk, and Vhk+1.

FIGS. 7A to 7G are timing charts showing the phase relationships of the video signal VDO when S/H=1 and the overlapped sampling pulses Vhk−1, Vhk, and Vhk+1 and a potential change of the signal line.

FIG. 8 is a view of a state where a ghost occurs in front in a horizontal scanning direction.

FIGS. 9A to 9G are timing charts showing the phase relationships of the video signal VDO when S/H=5 and the overlapped sampling pulses Vhk−1, Vhk, and Vhk+1 and the potential change of the signal line.

FIG. 10 is a view of a state where a ghost occurs behind in the horizontal scanning direction.

FIG. 11 is a circuit diagram of an example of the configuration of an active-matrix type liquid crystal display device using a point-sequence driving method according to an embodiment of the present invention.

FIGS. 12A to 12D are timing charts showing timing relationships between horizontal clocks HCK and HCKX and clocks DCK and DCKX.

FIGS. 13A to 13M are timing charts for explaining the operation of the clock driving method horizontal driving circuit according to the present embodiment.

FIGS. 14A to 14D are timing charts at the time of a sampling operation of the video signal in the clock driving method horizontal driving circuit according to the present embodiment.

FIGS. 15A to 15I are timing charts showing the phase relationships of the video signal VDO taking the sampling and holding position when S/H=0 to 5 and perfectly nonoverlapping sampling pulses Vhk−1, Vhk, and Vhk+1.

FIGS. 16A to 16G are timing charts showing the phase relationships of the video signal VDO when S/H=1 and the perfectly non-overlapping sampling pulses Vhk−1, Vhk, and Vhk+1 and the potential change of the signal line.

FIGS. 17A to 17G are timing charts showing the phase relationships of the video signal VDO when S/H=5 and the perfectly non-overlapping sampling pulses Vhk−1, Vhk, and Vhk+1 and the potential change of the signal line.

FIG. 18 is a block diagram of the configuration of a system of a projection type liquid crystal display device according to the present invention.

FIG. 19 is a schematic view of the configuration of an example of the configuration of an optical system of a projection type color liquid crystal display device.

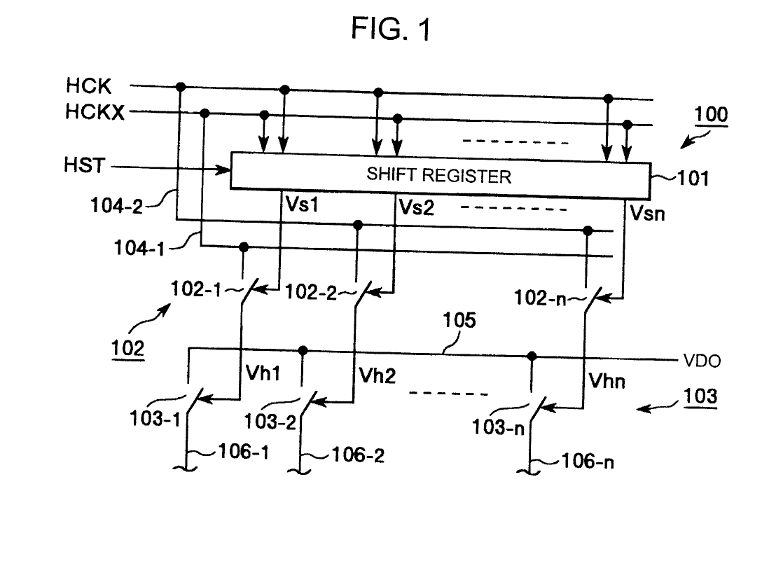

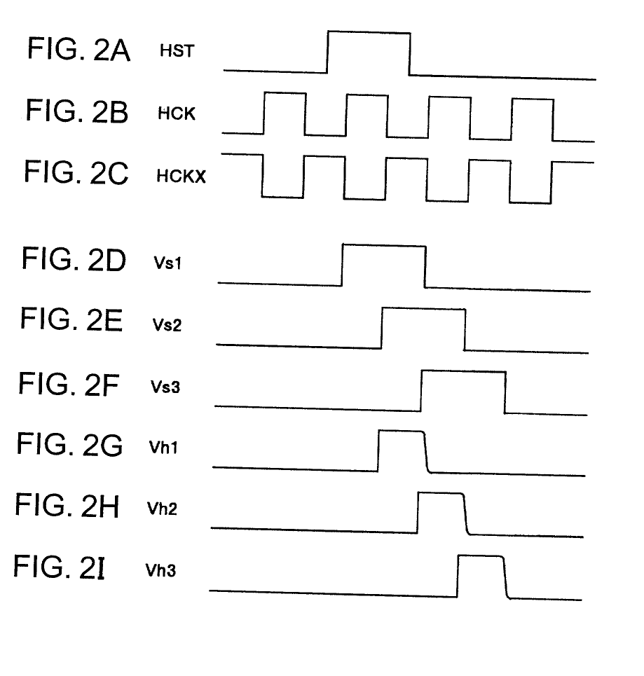

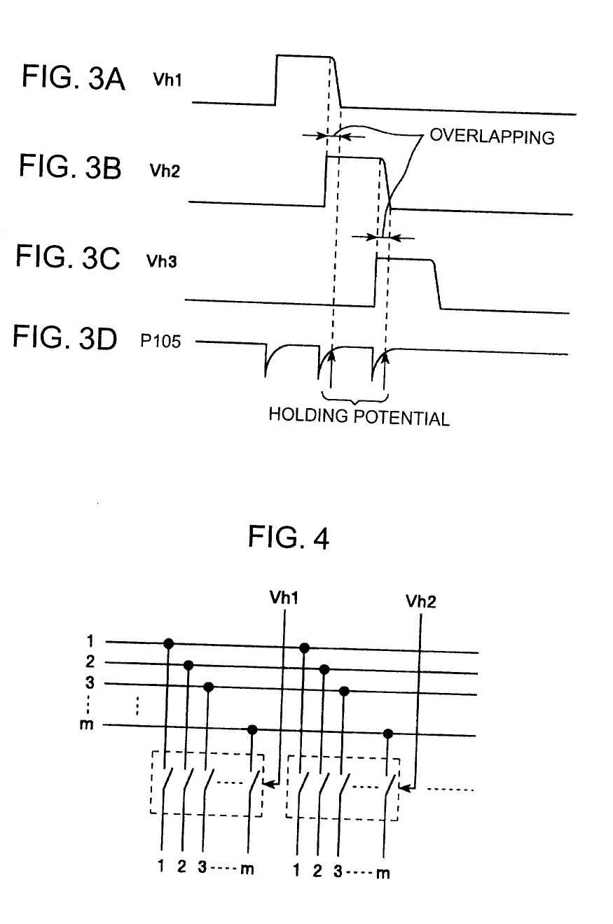

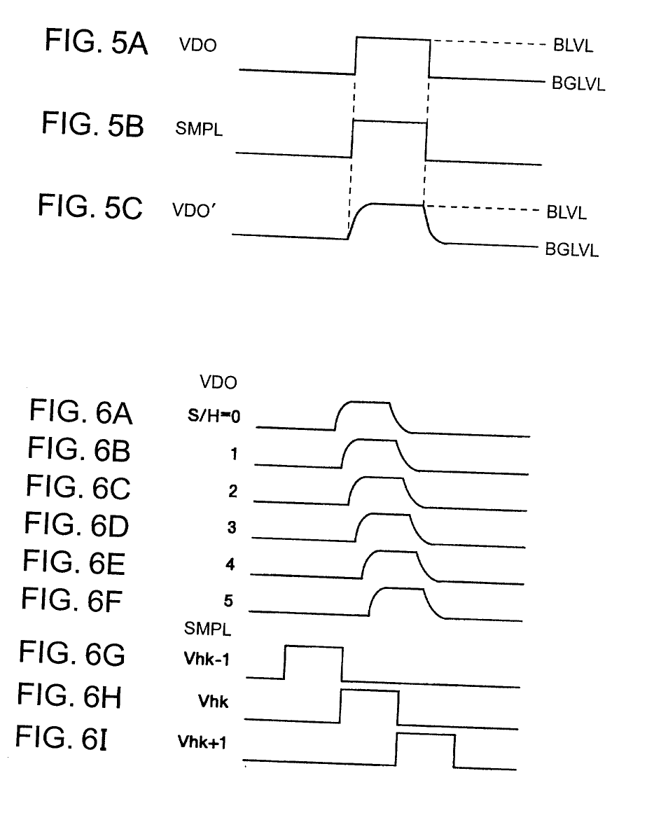

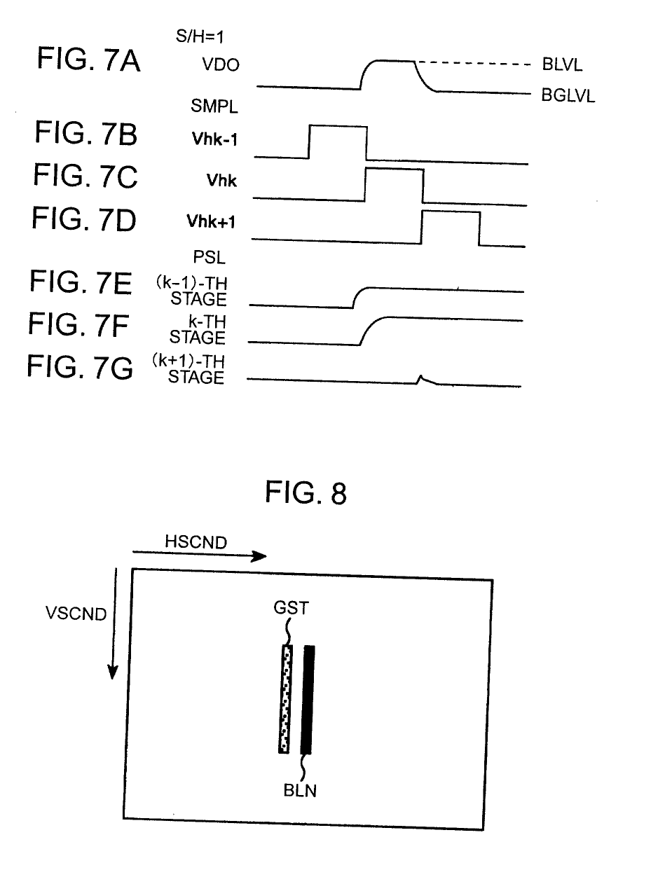

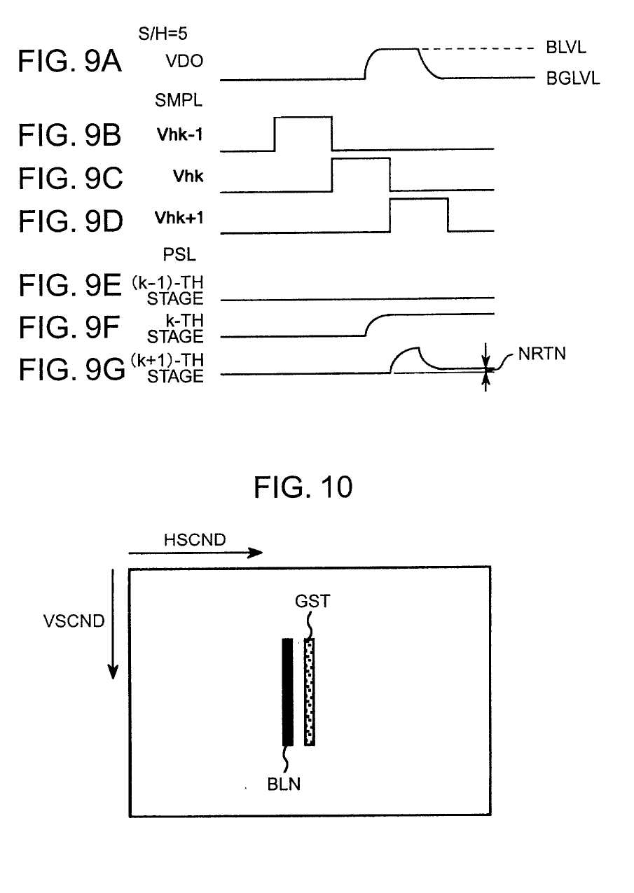

### BEST MODE FOR CARRYING OUT THE INVENTION

Below, a detailed explanation will be made of embodiments of the present invention by referring to the drawings.

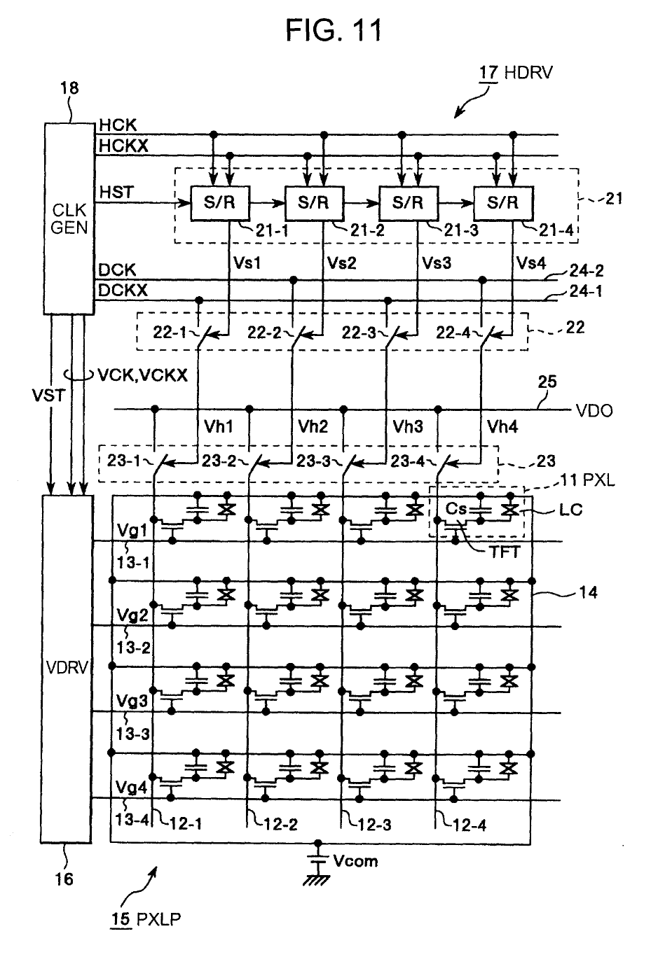

FIG. 11 is a circuit diagram of an example of the configuration of an active-matrix type liquid crystal display device using the point-sequence driving method according to an embodiment of the present invention using for example liquid-crystal cells as pixel display elements (electro-optical elements). Here, for simplification of the drawings, a case of a pixel array of 4 rows×4 columns is used as an example. Note that, in an active-matrix type liquid crystal display device, usually, a thin-film transistor (TFT) is used as a switching element for each pixel.

In FIG. 11, each of the pixels (PXL) 11 of the 4 rows and 4 columns arranged in a matrix is comprised of a pixel transistor, that is, a thin-film transistor TFT, a liquid-crystal cell LC whose pixel electrode is connected to a drain electrode of this thin-film transistor TFT, and a holding capacitor Cs one electrode of which is connected to the drain electrode of the thin-film transistor TFT. Signal lines 12-1 to 12-4 are laid for the columns of these pixels 11 along the pixel array direction, while gate lines 13-1 to 13-4 are laid for the rows along the pixel array direction.

In the pixels 11, source electrodes (or the drain electrodes) of the thin-film transistors TFT are connected to the corresponding signal lines 12-1 to 12-4. Gate electrodes of the thin-film transistors TFT are connected to the corresponding gate lines 13-1 to 13-4. The counter electrodes of the liquid-crystal cells LC and the other electrodes of the holding capacitors Cs are connected to a Cs line 14 common for the pixels. A predetermined DC voltage is supplied as a common voltage Vcom to this Cs line 14.

As a result of the above, a pixel part (PXLP) 15 is formed in which pixels 11 are arranged in a matrix, signal lines 12-1 to 12-4 are laid for the columns of these pixels 11, and gate lines 13-1 to 13-4 are laid for the rows. In this pixel part 15, one end of each of the gate lines 13-1 to 13-4 is connected to an output end of each row of a vertical driving circuit (VDRV) 16 disposed, for example, to the left of the pixel part 15.

The vertical driving circuit 16 performs processing for scanning in the vertical direction (row direction) at each field period so as to select the pixels 11 connected to the gate lines 13-1 to 13-4 in sequence in row units. Namely, when a scanning pulse Vg1 is supplied from the vertical driving circuit 16 to the gate line 13-1, the pixels of the columns of the first row are selected, while when a scanning pulse Vg2 is supplied to the gate line 13-2, the pixels of the columns of the second row are selected. Hereinafter, in a similar manner, scanning pulses Vg3 and Vg4 are supplied in sequence to the gate lines 13-3 and 13-4.

Above for example the pixel part 15, a horizontal driving circuit (HDRV) 17 is disposed. Also, a clock generating circuit (CLKGEN: timing generator) 18 for supplying various clock signals to the vertical driving circuit 16 and the horizontal driving circuit 17 is provided. This clock generating circuit 18 generates a vertical start pulse VST for instructing the start of vertical scanning, opposite phase vertical clocks VCK and VCKX serving as a vertical scanning reference, a vertical start pulse VST for instructing the start of horizontal scanning, and opposite phase horizontal clocks HCK and HCKX serving as a horizontal scanning reference.

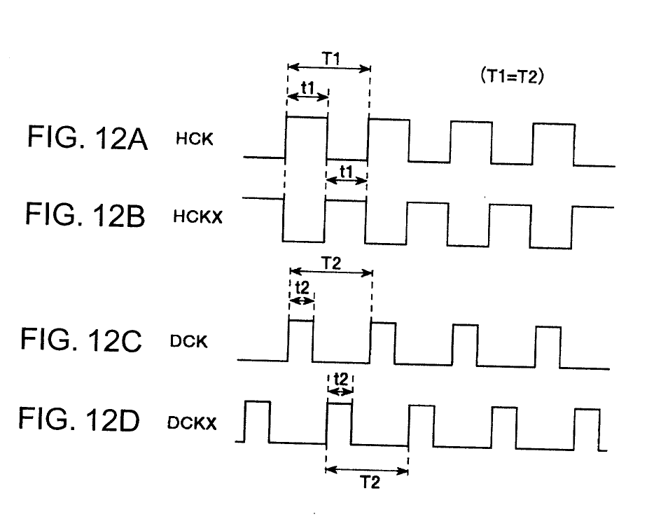

The clock generating circuit 18, furthermore, as shown in the timing charts of FIGS. 12A to 12D, also generates opposite phase clocks DCK and DCKX having the same period (T1=T2) as that of the horizontal clocks HCK and HCKX and having a smaller duty ratio. Here, the duty ratio is a ratio of the pulse width t to the pulse repetition period T in the pulse waveform.

In the case of the present example, the duty ratio (t1/T1) of the horizontal clocks HCK and HCKX is 50%, and the duty ratio (t2/T2) of the clocks DCK and DCKX is set to be smaller than this percentage, that is, the pulse width t2 of the clocks DCK and DCKX is set to be smaller than the pulse width t1 of the horizontal clocks HCK and HCKX.

The horizontal driving circuit 17 is for sampling the input video signal VDO in sequence at intervals of 1H (H is the horizontal scanning period) and for performing a writing process on each pixel 11 selected in row units by the vertical driving circuit 16. The present example is configured employing a clock driving method and having a shift register 21, a clock sampling switch group 22, and a sampling switch group 23.

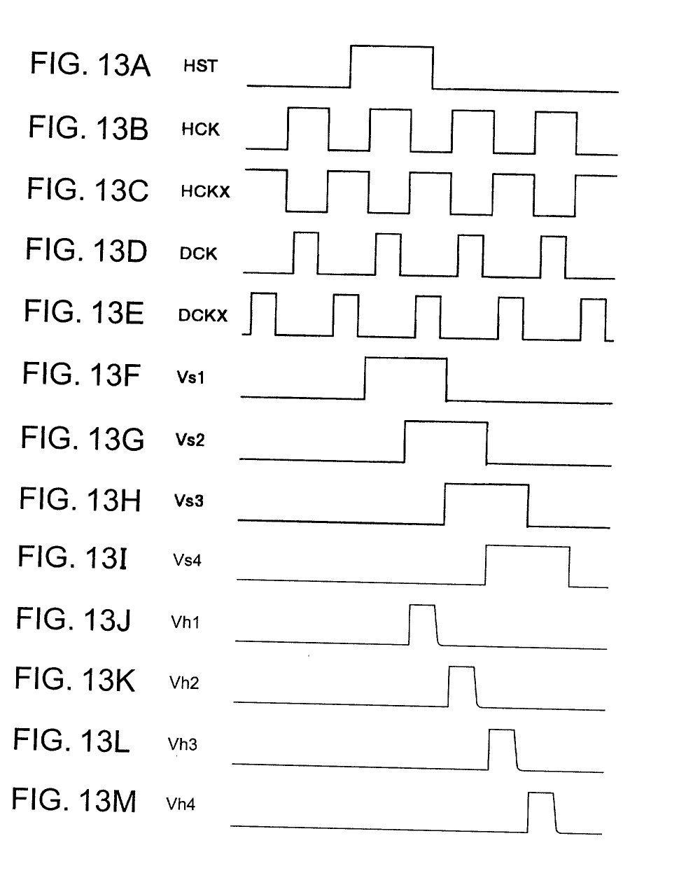

The shift register 21 is comprised by four shift stages (S/R stages) 21-1 to 21-4 corresponding to the pixel strings of the pixel part 15 (in the present example, four columns). When the horizontal start pulse HST is given, the shift register 21 performs a shift operation in synchronization with the opposite phase horizontal clocks HCK and HCKX. As a result, the shift stages 21-1 to 21-4 of the shift register 21, as shown in the timing charts of FIGS. 13A to 13M, output in sequence shift pulses Vs1 to Vs4 having the same pulse width as the period of the horizontal clocks HCK and HCKX.

The clock sampling switch group 22 is formed of four switches 22-1 to 22-4 corresponding to the pixel strings of the pixel part 15. Ends of each of these switches 22-1 to 22-4 are alternately connected to the clock lines 24-1 and 24-2 which transmit the clocks DCKX and DCK from the clock generating circuit 18. Namely, one end of each of the switches 22-1 and 22-3 is connected to the clock line 24-1, and one end of each of the switches 22-2 and 22-4 is connected to the clock line 24-2.

The shift pulses Vs1 to Vs4 which are output in sequence from the shift stages 21-1 to 21-4 of the shift register 21 are supplied to the switches 22-1 to 22-4 of the clock sampling switch group 22. When the shift pulses Vs1 to Vs4 are supplied from the shift stages 21-1 to 21-4 of the shift register 21 to the switches 22-1 to 22-4 of the clock sampling switch group 22, the switches 22-1 to 22-4 are turned on in sequence in response to these shift pulses Vs1 to Vs4, thereby alternately sampling the opposite phase clocks DCKX and DCK.

The sampling switch group 23 is formed of four switches 23-1 to 23-4 corresponding to the pixel strings of the pixel part 15. One end of each of these switches 23-1 to 23-4 is connected to a video line 25 receiving a video signal VDO as input. The clocks DCKX and DCK, which are sampled by the switches 22-1 to 22-4 of the clock sampling switch group 22, are supplied, as sampling pulses Vh1 to Vh4, to the switches 23-1 to 23-4 of this sampling switch group 23.

When the sampling pulses Vh1 to Vh4 are supplied from the switches 22-1 to 22-4 of the clock sampling switch group 22, the switches 23-1 to 23-4 of the sampling switch group 23 are turned on in sequence in response to these sampling pulses Vh1 to Vh4, thereby sequentially sampling the video signal VDO which is input through the video line 25, and supply the signal to the signal lines 12-1 to 12-4 of the pixel part 15.

In the horizontal driving circuit 17 having the above-described configuration according to the present embodiment, rather than using the shift pulses Vs1 to Vs4 which are output in sequence from the shift register 21 as the sampling pulses Vh1 to Vh4, the opposite phase clocks DCKX and DCK are sampled alternately in synchronization with the sampling pulses Vh1 to Vh4 and these clocks DCKX and DCK are used directly as the sampling pulses Vh1 to Vh4, making it possible to suppress variations of the sampling pulses Vh1 to Vh4. As a result, it becomes possible to eliminate ghosts caused by variations of the sampling pulses Vh1 to Vh4.

In addition, in the horizontal driving circuit 17 according to the present embodiment, rather than sampling the horizontal clocks HCKX and HCK which serve as a reference for the shift operation of the shift register 21 and using them as the sampling pulses Vh1 to Vh4 as in the related art, the clocks DCKX and DCK having the same period as that of the horizontal clocks HCKX and HCK and having a smaller duty ratio are separately generated. These clocks DCKX and DCK are sampled and used as the sampling pulses Vh1 to Vh4. As a consequence, the operation and effect such as those described below are obtained.

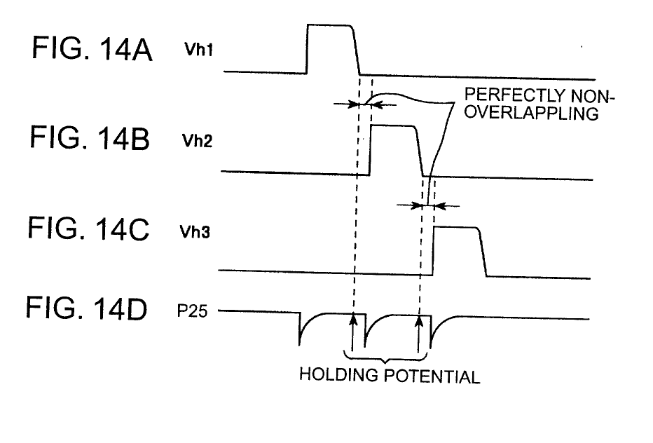

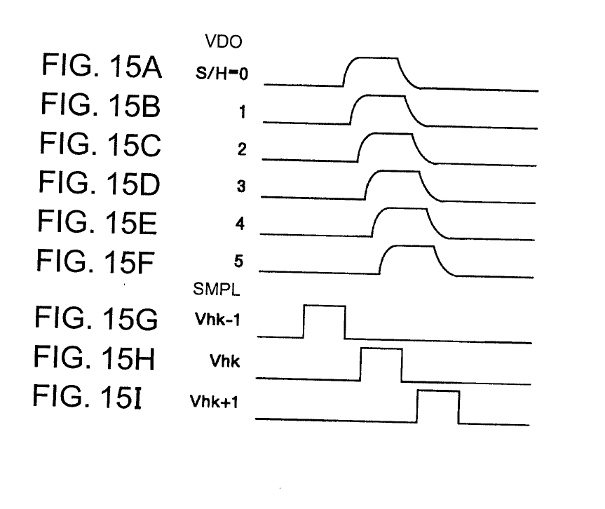

More specifically, during the transmission process from when the clocks DCKX and DCK are sampled by the switches 22-1 to 22-4 of the clock sampling switch group 22 until these are supplied to the switches 23-1 to 23-4 of the sampling switch group 23, even if a delay occurs in the pulses due to wiring resistance, parasitic capacitance, etc. and rounding occurs in the waveform of the sampled clocks DCKX and DCK, as is clear from, in particular, the timing charts of FIGS. 14A to 14D, each of the sampled clocks DCKX and DCK has a perfectly non-overlapping waveform with respect to the previous and subsequent pulses. Note that, FIG. 14D shows a potential P25 of the video line 25.

Then, by using the clocks DCKX and DCK of the perfectly non-overlapping waveforms as the sampling pulses Vh1 to Vh4, in the sampling switch group 23, when a particular k-th stage is considered, the sampling of the video signal VDO by the sampling switch of the k-th stage can always be completed before the sampling switch of the (k+1)-th stage is turned on.

As a result, even if a charging/discharging noise is carried in the video line 25 at the instant when the switches 23-1 to 23-4 of the sampling switch group 23 are turned on, since, as shown in FIGS. 14A to 14D, sampling of the subsequent stage is always performed before a charging/discharging noise is generated due to the switching of the next stage, it is possible to prevent sampling of the charging/discharging noise. As a result, it is possible to suppress the occurrence of streaks caused by over-sampling during horizontal driving.

Also, since perfectly non-overlapping sampling can be realized, the ghost margin without occurrence of ghosts can be made larger than the conventional case. This point will be explained in detail below.

FIGS. 15A to 15I show phase relationships between the video signal VDO taking the sampling and holding positions of for example S/H=0 to 5 and the perfectly non-overlapping sampling pulses (SMPL) Vhk−1, Vhk, and Vhk+1.

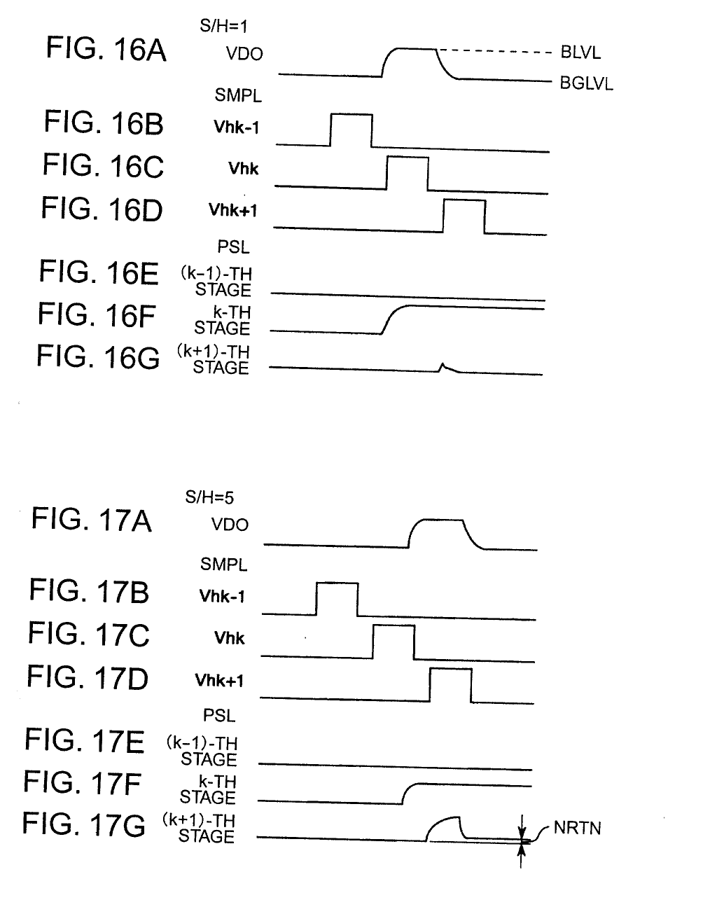

First, the time when S/H=1 will be considered. The phase relationships between the video signal VDO when S/H =1 and the sampling pulses (SMPL) Vhk−1, Vhk, and Vhk+1 and the change of the potential PLS of the signal line are shown in FIGS. 16A to 16G. Note that, BLVL of FIG. 16A indicates the black level, and BGLVL indicates the background gray level.

When S/H=1, the sampling pulse Vhk−1 of the (k−1)-th stage and the black signal section (pulse section) of the video signal VDO do not overlap. Accordingly, when sampling the pulse-state video signal VDO by the sampling pulse Vhk, the black signal is written into only the signal line of the k-th stage, so ghosts do not occur in front in the horizontal scanning direction.

Next, the time when S/H=5 will be considered. The phase relationships between the video signal VDO when S/H =5 and the sampling pulses (SMPL) Vhk−1, Vhk, and Vhk+1, and the change of the potential PLS of the signal line are shown in FIGS. 17A to 17G.

When S/H=5, the video black signal overlaps the sampling pulse Vhk+1 of the (k+1)-th stage. The black signal is written into the signal line of the (k+1)-th stage when the sampling switch is turned on, then the line tries to return to the gray level. However, since the amount of overlap is large, the potential of the signal line does not completely return to the gray level by exactly the amount indicated by NRTN in FIG. 17G. Accordingly, a ghost occurs behind in the horizontal scanning direction.

Also, when S/H=1 to 4, in the same way as the time when S/H=5, the sampling pulse Vhk+1 of the (k+1)-th stage and the video black signal section overlap each other, and the black signal is written into the signal line when the sampling switch is turned on. However, the amount of overlap is smaller and the written black level is lower in comparison with the time when S/H=5, so the potential of the signal line can completely return to the gray level. Accordingly, no ghost occurs behind in the horizontal scanning direction.

Here, since the sampling pulses Vhk−1, Vhk, and Vhk+1 overlap each other, when comparing with the case of the related art wherein there is overlapping sampling, while the ghost margins is the three S/H=2, 3, and 4 in the prior art, it is the S/H=2, 3, and 4 plus the two S/H=0 and 1, that is, the total five ghost margin in the present method of the perfectly non-overlapping sampling, so the ghost margin can be raised.

Note that, although the above-described embodiment describes a case where the present invention is applied to an liquid crystal display device mounting an analog interface driving circuit receiving an analog video signal as input and sampling this signal in order to drive each pixel in a point sequence, it is also possible to similarly apply the present invention to an liquid crystal display device mounting a digital interface driving circuit receiving a digital video signal as input, latching this signal, and then converting this signal into an analog video signal, sampling this analog video signal, and driving each pixel in a point sequence.

Although the above-described embodiment describes, as an example, a case where the present invention is applied to a liquid crystal display device which uses liquid-crystal cells as display elements (electro-optical elements) of pixels, the present invention is not limited to application to an LCD device and can be applied to active-matrix type liquid crystal display devices in general using a point-sequence driving method employing a clock driving method for horizontal driving circuits, for example an active-matrix-type EL display device using an electroluminescence (EL) element as the display element of each pixel.

Examples of the point-sequence driving method include, in addition to the well known 1H inversion driving method and dot inversion driving method, the so-called dot line inversion driving method in which video signals having opposite polarities are written simultaneously into the pixels of two rows separated by odd-numbered rows among adjacent pixel strings, for example, the pixels of two rows, i.e., an upper row and a lower row, so that the polarities of the pixels become the same in the right and left adjacent pixels and become opposite polarities in the upper and lower pixels in the pixel array after the video signals are written.

The active-matrix-type liquid crystal display device using the point-sequence driving method according to the embodiment explained above can be used as a display panel of a projection type liquid crystal display device (liquid-crystal projector), that is, an LCD (liquid-crystal display) panel.

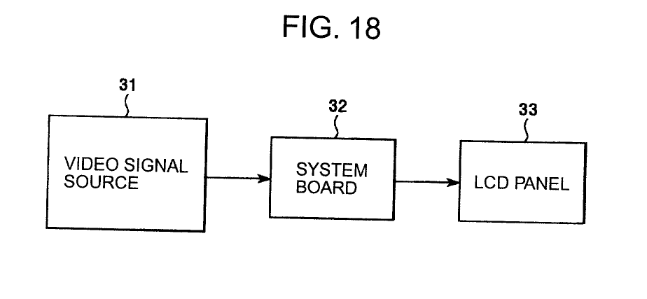

FIG. 18 is a block diagram of the system configuration of the projection type liquid crystal display device. The projection type liquid crystal display device according to the present example is comprised of a video signal source 31, system board 32, and LCD panel 33.

In this system configuration, the system board 32 performs signal processing such as adjustment of the above mentioned sampling and holding position with respect to a video signal which is output from the video signal source 31. The system board 32 also mounts the clock generating circuit (timing generator) 18 of FIG. 11. Further, as the LCD panel 33, use is made of an active-matrix type liquid crystal display device using the point-sequence driving method according to the above mentioned embodiment. Also, in the case of color, LCD panels 33 are provided corresponding to R (red), G (green), and B (blue).

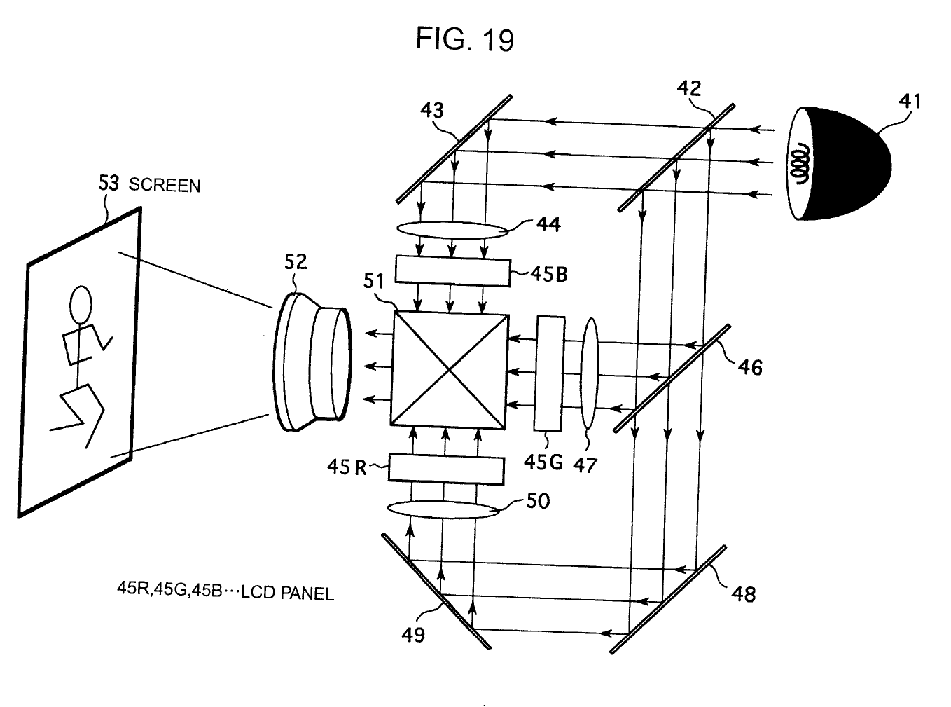

FIG. 19 is a schematic view of the configuration showing an example of the configuration of the optical system of the projection type color liquid crystal display device. In FIG. 19, only a specific color component in white light emitted from a light source 41, for example, a B (blue) component having the shortest wavelength, passes through a first beam splitter 42, while the remaining color components are reflected. The B component passed through the first beam splitter 42 is changed in its optical path at a mirror 43 and emitted to an LCD panel 45B through a lens 44.

Among the light components reflected at the first beam splitter 42, the for example G (green) component is reflected at a second beam splitter 46, while the R (red) component passes through it. The G component reflected at the second beam splitter 46 is emitted to a G LCD panel 45G through a lens 47. The R component passed through the second beam splitter 46 is changed in its optical path at mirrors 48 and 49 and emitted to an R LCD panel 45R through a lens 50. Each of the LCD panels 45R, 45G, and 45B is configured by a first base plate having a plurality of pixels arranged in a matrix, a second base plate oppositely arranged with a predetermined interval with respect to this first base plate, a liquid-crystal layer held between these base plates, and filter layers corresponding to the colors. The R, G, and B light components passing through these LCD panels 45R, 45G, and 45B are optically combined by a cross prism 51. Then, the composite light emitted from this cross prism 51 is projected to a screen 53 by a projection prism 52.

In the projection type liquid crystal display device having the above-described configuration, by using active-matrix type liquid crystal display devices using the point-sequence driving method according to the above mentioned embodiment as the LCD panels 45R, 45G, and 45B, perfectly non-overlapping sampling is realized in the horizontal driving system in the related liquid crystal display devices, whereby the occurrence of streaks caused by overlapping sampling can be suppressed, and the ghost margin can be raised, so a higher quality image display can be realized.

Note that projection type liquid crystal display devices include a rear type and a front type. In general, a rear type projection type liquid crystal display device has been used as a projection TV for moving pictures, while a front type projection type liquid crystal display device has been used as a data projector, but the active-matrix type liquid crystal display device using the point-sequence driving method according to the above mentioned embodiment can be applied to both types. Also, here, an explanation was made of the case where the present invention was applied to a color projection type liquid crystal display device as an example, but the present invention can be similarly applied also to a monochrome projection type liquid crystal display device.

Industrial Applicability

As explained above, according to the present invention, in an active-matrix type display device using the point-sequence driving method, when performing horizontal driving by the clock driving method, a second clock signal having the same period and having a smaller duty ratio than a first clock signal serving as a horizontal scanning reference is generated, this second clock signal is sampled, and the video signal is sampled using this as the sampling pulse, whereby perfectly non-overlapping sampling can be realized, so the occurrence of streaks caused by overlapping sampling can be suppressed, and the ghost margin can be raised.

List of References

11 . . . pixel

12-1 to 12-4 . . . signal lines

13-1 to 13-4 . . . gate lines

15 . . . pixel part

16 . . . vertical driving circuit

17 . . . horizontal driving circuit

18 . . . clock generation circuit

21 . . . shift register

22 . . . clock sampling switch group

23 . . . sampling switch group

1. A display device, comprising:
a pixel part comprised of pixels arranged in a matrix and having a signal line arranged for each pixel string,
a clock generating means for generating a first clock signal serving as a reference for horizontal scanning and generating a second clock signal having the same period and having a smaller duty ratio than the first clock signal,
a shift register for performing a shift operation in synchronization with said first clock signal and outputting a shift pulse in sequence from the shift stages,
a first switch group for sampling said second clock signal in response to a shift pulse output in sequence from said shift register, and
a second switch group for sampling an input video signal in sequence in response to said second clock signal sampled by the switches of the first switch group and supplying the same to the signal lines of the pixel part.

2. A display device as set forth in claim 1, wherein a display element of each pixel of said pixel part is a liquid-crystal cell.

3. A method of driving a display device for obtaining shift pulses in sequence in synchronization with a first clock signal at the time of horizontal scanning with respect to a pixel part comprised by pixels arranged in a matrix and having a signal line arranged for each pixel string and for supplying a video signal to the signal line of said pixel part while sampling the video signal based on these shift pulses, comprising:
generating a second clock signal having the same period and having a smaller duty ratio than the first clock signal,
sampling the second clock pulse based on the shift pulse and using it as the sampling pulse, and
supplying the video signal to a signal line of the pixel part while sampling the video signal by this sampling pulse.

4. A method of driving a display device as set forth in claim 3, wherein a display element of each pixel of said pixel part is a liquid-crystal cell.

5. A projection type display device, comprising:
a clock generating means for generating a first clock signal serving as a reference for horizontal scanning and generating a second clock signal having the same period and having a smaller duty ratio than the first clock signal,
a display panel having a pixel part comprised by pixels arranged in a matrix and having a signal line arranged for each pixel string and a horizontal driving system for sampling said second clock signal based on a shift pulse obtained in sequence in synchronization with said first clock signal and sampling an input video signal in sequence in response to said sampled second clock signal and supplying the same to the signal lines of the pixel part,
an emitting means for emitting light to said display panel, and
a projecting means for projecting light passing through the display panel to a screen.

6. A projection type display device as set forth in claim 5, wherein a display element of each pixel of said pixel part is a liquid-crystal cell.
